(19) United States
(12) Patent Application Publication
(10) Pub. No.: US 2015/0101025 A1
(43) Pub. Date: Apr. 9, 2015

(54) IMAGE FORMING APPARATUS, METHOD OF CONTROLLING THE SAME, AND STORAGE MEDIUM

(71) Applicant: CANON KABUSHIKI KAISHA, Tokyo (JP)

(72) Inventors: Tomomi Murata, Tokyo (JP); Takahiro Onsen, Yokohama-shi (JP)

(21) Appl. No.: 14/487,546

(22) Filed: Sep. 16, 2014

(30) Foreign Application Priority Data
Oct. 8, 2013 (JP) 2013-211431

(51) Int. Cl. H04L 29/06; G06F 21/10

(52) U.S. Cl. CPC H04L 63/08; G06F 21/10
USPC 726/4; 726/26

(57) ABSTRACT

An image forming apparatus, and a method of controlling the apparatus, capable of executing a Web browser application and a cooperation application for cooperating with a server, determines whether a license of the Web browser application is valid and whether the cooperation application for cooperating with the server is valid, and in accordance with the determinations, displays a screen of the Web browser application in which a display item is restricted.

### BACKGROUND OF THE INVENTION

1. Field of the Invention

The present invention relates to an image forming apparatus, a method of controlling the same, and a storage medium.

2. Description of the Related Art

In recent years, services, in which an image forming apparatus, comprising various functions such as a printing function, a scanner function, a FAX function, or a document storing function, is connected to a Web server on a network, that generates a PDF format electronic document, and services in which electronic documents are accumulated, or the like, are being provided. By using these kinds of services, a user, on top of being able to generate a PDF even in a case where there is no PDF generation function on a terminal that the user possesses itself, is able to store electronic documents in a storage capacity greater than that of the user's own terminal.

Also, in recent years, accompanying the universalization of cloud, opportunities to create additional value by allowing the previously described plurality of services to cooperate are increasing more and more. By allowing services to cooperate in this way, a service provider is able to provide additional value to users. For example, generated PDF format electronic documents can be stored directly on the Internet without going through a terminal that a user possesses. Meanwhile, due to services cooperating, various problems arise. For example, there is a risk that due to more information than a user wishes being exchanged between services, user data or personal information leaks. While multiple services exist on the Internet, and service cooperation is realized between various services, it is undesirable that services, other than services that provide results that the user desires, obtain user data, personal information, or the like. Meanwhile, from the perspective of the service provider, it is advantageous that a service cooperation arrangement be easily implementable.

In such circumstances, a standard protocol referred to as OAuth for realizing an authorization cooperation has been established. Refer to “The OAuth 1.0 Protocol”, [online] E. Hammer-Lahav, published in September, 2012 URL http://tools.ietf.org/html/rfc5849 “The OAuth 2.0 Authorization Framework draft-ietf-OAuth-v2-31”, [online] D. Hardt., published in September, 2012, URL http://tools.ietf.org/html/draft-ietf-OAuth-v2-31”, for example, which explains in further detail about OAuth. With OAuth, it is possible for an external service B, authorized by a user, to access data of the user that a service A, for example, manages. Here, after making clear a range that can be accessed from the external service B, the service A obtains an explicit approval of the user for access by the external service B. Here, the user explicitly performing approval is referred to as an authorization operation. When the user performs the authorization operation, the external service B can receive a token (hereinafter referred to as an access token) for certifying that access was authorized from the service A, and access thereafter can be realized using this access token. When the access token is used, the external service B is able to access the service A, with an authority of a user that performed an authorization, without user authorization information. For this reason, the external service B, having received authorization from the user and obtained the access token, has the responsibility of managing the access token strictly and appropriately. With this, it becomes possible for a service provider to easily provide a cooperation result using services that the user desires while avoiding the risks of leakage of the personal information of the user.

The image forming apparatus becomes capable of cooperating with the cloud service by the user transferring a cloud service resource access authority to the image forming apparatus in a case where the image forming apparatus cooperates with a cloud service as an OAuth client. Because the image processing apparatus is shareable between a plurality users, performing the management of a plurality of users is common. Accordingly, it is not preferable that all of the users of the image processing apparatus become capable of accessing the cloud service resources of the user that transferred the authority to the image forming apparatus, and so cooperation between a user of the cloud service and a user of the image forming apparatus is required. In order for cooperation between the user of the cloud service and the user of the image forming apparatus, the user of the image forming apparatus and the access token are linked, and the link is stored in the image forming apparatus. Then, by the user of the image forming apparatus accessing the cloud service using the access token linked to the user that logged in to the image forming apparatus, access to the cooperating cloud service in the range of authority of the user that the user of the cloud service approved becomes possible.

Here it is necessary for the user to transfer the authority using a Web browser in a state in which the user is logged in to the image forming apparatus, in order to link the user of the image forming apparatus to the access token. Here, the user manually inputs an address (URL) for accessing an application, which is a provider for linking the access token, into an address designation region of the Web browser. The application that is the provider requests (redirect) of the cloud service (authentication service) authentication for issuing the access token, and the user performs authentication on the Web browser. When the user completes the authentication on the Web browser, the provider obtains the access token that the authentication service issues, and stores the access token linked to the user on the image forming apparatus. With this, it is possible to assign a cloud service user authority linked to a user of an image forming apparatus.

Here the functions of the Web browser required upon transferring of authority of the user, and the functions required upon standard usage are different. For this reason, upon the transferring of authority of the user, usage of a portion of the functions of the Web browser is restricted. In Japanese Patent Laid-Open No. 2006-155522, for example, an approach for restricting the functions of a Web browser is proposed. In this document, it is recited that the usage of a portion of the functions of a Web browser is restricted by setting operation instruction restriction content, and causing a state in which selection by the user of a tool portion corresponding to the set restriction content is impossible.

The Web browser is a client application for accessing and browsing external sites, and is arranged on an image forming apparatus in advance. Normally, when a Web browser is used, it is necessary for the user to purchase and install a license of the Web browser on the image forming apparatus. Even if the Web browser is arranged on the image forming apparatus, the user cannot activate the Web browser if the license is not installed.

Meanwhile, in order for the image forming apparatus to cooperate with the cloud service as an OAuth client as previously explained, it is necessary for a user to transfer the authority of the user by operating the Web browser and performing the authentication. Here as well, if the license of the Web browser is not installed, the Web browser cannot be used by the user.

Meanwhile, it is desirable that usage of the Web browser be permitted in a case where the Web browser is used for the purpose of cooperating with the cloud service, even if the license of the Web browser is not installed. Also, a situation arises in which it is unfair to users that purchased a license if usage of the Web browser is permitted even in the case where the license of the Web browser is not installed.

### SUMMARY OF THE INVENTION

An aspect of the present invention is to eliminate the above-mentioned problems with conventional technology.

A feature of the present invention is to provide a technique for cooperating with a resource service in which even a user who does not have a license for a Web browser is able to instruct the cooperation, by using the Web browser without a situation that is unfair to users that purchased the license for the Web browser arising.

The present invention in its first aspect provides an image forming apparatus capable of executing a Web browser application and a cooperation application for cooperating with a server, the apparatus comprising: a first determination unit configured to determine whether or not a license of the Web browser application is valid; a second determination unit configured to determine whether or not the cooperation application for cooperating with the server is valid; and a display control unit configured to display a screen of the Web browser application in which a display item is restricted in accordance with the determinations by the first determination unit and the second determination unit.

The present invention in its second aspect provides a method of controlling an image forming apparatus capable of executing a Web browser application and a cooperation application for cooperating with a server, the method comprising: determining whether or not a license of the Web browser application is valid; determining whether or not the cooperation application for cooperating with the server is valid; and displaying a screen of the Web browser application in which a display item is restricted in accordance with the determinations in the determining steps.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 depicts a view for showing a configuration of a communication system according to a first embodiment.

FIG. 2 is a block diagram for showing hardware configurations of an authorization server and an image forming apparatus according to the first embodiment.

FIG. 3 depicts a view for showing a configuration of each software module of the authorization server, a resource server and the image forming apparatus according to the first embodiment.

FIGS. 4A through 4C depict views for explaining data tables stored in an external memory by the authorization server according to the first embodiment.

FIGS. 5A through 5D depict views for explaining data tables stored in an external memory by the image forming apparatus according to the first embodiment.

FIG. 6 depicts a view for illustrating an example of a list of display-restricted items according to the first embodiment.

FIG. 7 depicts a view for illustrating an example of a screen, displayed by a normal Web browser, for which a resource service cooperation is not performed, and which is not a resource service cooperation browser display.

FIG. 8 depicts a view for illustrating an example of a screen, displayed by a Web browser where a license is installed, which is a resource service cooperation browser display.

FIG. 9 depicts a view for illustrating an example of a screen, displayed by the Web browser where a license of the Web browser is not yet installed, which is a resource service cooperation browser display.

FIGS. 10A and 10B are flowcharts for describing a registration or an update of client information and registration processing of a Web browser shortcut upon activation of an authorization server cooperation client according to the first embodiment.

FIG. 11 depicts a view for explaining a parent token obtainment sequence of the image forming apparatus according to the first embodiment.

FIG. 12A depicts a view for illustrating an example of a login screen, for authenticating a user, which is displayed by the Web browser of the image forming apparatus according to the first embodiment.

FIG. 12B depicts a view for illustrating an example of authorization confirmation screen displayed by the Web browser of the image forming apparatus according to the first embodiment.

FIG. 13 is a flowchart for describing processing for determining display items in accordance with display item restrictions in FIG. 6 when a screen is displayed by the Web browser of the image forming apparatus according to the first embodiment.

FIG. 14 depicts a view for illustrating an example of a Web browser shortcut table according to a second embodiment of the present invention.

FIGS. 15A and 15B are flowcharts for describing processing of obtaining a list of display-restricted items by the image forming apparatus according to the second embodiment.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

It is assumed that a business form service for generating business form data on the Internet and a print service for obtaining and printing data on the Internet are installed in a server on the Internet in the present embodiment. Hereinafter, a service for providing functions on the Internet, such as the business form service and the print service, is referred to as a “resource service”.

It is also assumed that a printing application and a business form application installed in an image forming apparatus utilize the resource service in the present embodiment. Hereinafter, an application for using the resource service, such as the printing application and the business form application, is called a “cooperation application”. Of course, the resource service is not limited to the business form service or the print service, and the cooperation application is not limited to the business form application or the printing application.

Furthermore, an arrangement of OAuth is used for a transferring of authority in the embodiments. Information called a token (access token) is used as information for certifying an authority transferred from a user in OAuth.

It is necessary for a user to provide each authorization individually to the printing application in a case where the resource service is used from the printing application, and to the business form application in a case where the resource service is used from the business form application. Considering from a user's perspective, for example, enabling usage of the resource service for all respective cooperation applications with single authorization operation in a case where resource services are used from the same image forming apparatus is more convenient.

An authority of a user is therefore transferred to a device such as an image forming apparatus in the present embodiment. Then, when the authority is transferred to the cooperation application, the number of times that the authorization operation of the user is performed is reduced by the image forming apparatus transferring the authority to the cooperation application in place of the user. That is, by the step of transferring the authority to the image forming apparatus, it is recognized that the authority is also transferred to the cooperation application by the user. A token for when a user transfers the authority to the image forming apparatus is referred to “a parent token”.

As an approach (scheme) for performing the user's authorization operations all at one time, an approach where the parent token obtained by the image forming apparatus is shared between the cooperation applications of the image forming apparatus can be considered. However, it is not preferable because all of cooperation applications sharing the parent token become capable of accessing all of the resource services in this scheme. This is because, in a case where the cooperation application accesses the resource service using the shared parent token, the resource service side cannot identify the cooperation application of the accessing party, and it is not be able to determine whether or not usage is allowed. In the present embodiment, the individual cooperation applications do not use the parent token directly, but rather use a token which is inherited from information transferred for the parent token and which is retransferred and issued for each cooperation application. Here, the tokens for which the parent token is retransferred and issued for each the cooperation application are referred to as “child tokens”.

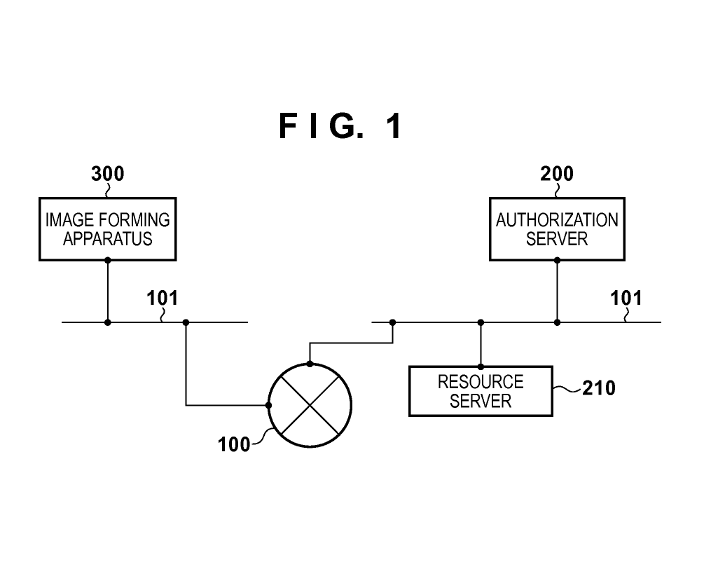

FIG. 1 depicts a view for showing a configuration of a communication system according to the first embodiment.

A WAN 100 is a Wide Area Network, and a World Wide Web (WWW) system is constructed in the first embodiment. A LAN 101 is a local area network connecting each configuration element. An authorization server 200 is an authorization server for realizing OAuth, and comprises an authorization service module. A resource server 210 comprises resource services such as a print service or a business form service. Note, there may be one or more resource services installed in one resource server. An image forming apparatus 300 is a multi function peripheral, capable of, for example, printing or scanning an image, in which one or more cooperation applications are installed. Furthermore, a new cooperation application can be installed and added. A user is able to use a resource service using a cooperation application of the image forming apparatus 300. The authorization server 200, the resource server 210 and the image forming apparatus 300 are also connected via the WAN 100 and the LAN 101 respectively. Note, the authorization server 200, the resource server 210 and the image forming apparatus 300 may each be arranged on separate individual LANs, and may be arranged on the same LAN. Also, the authorization server 200 and the resource server 210 may be configured on the same server.

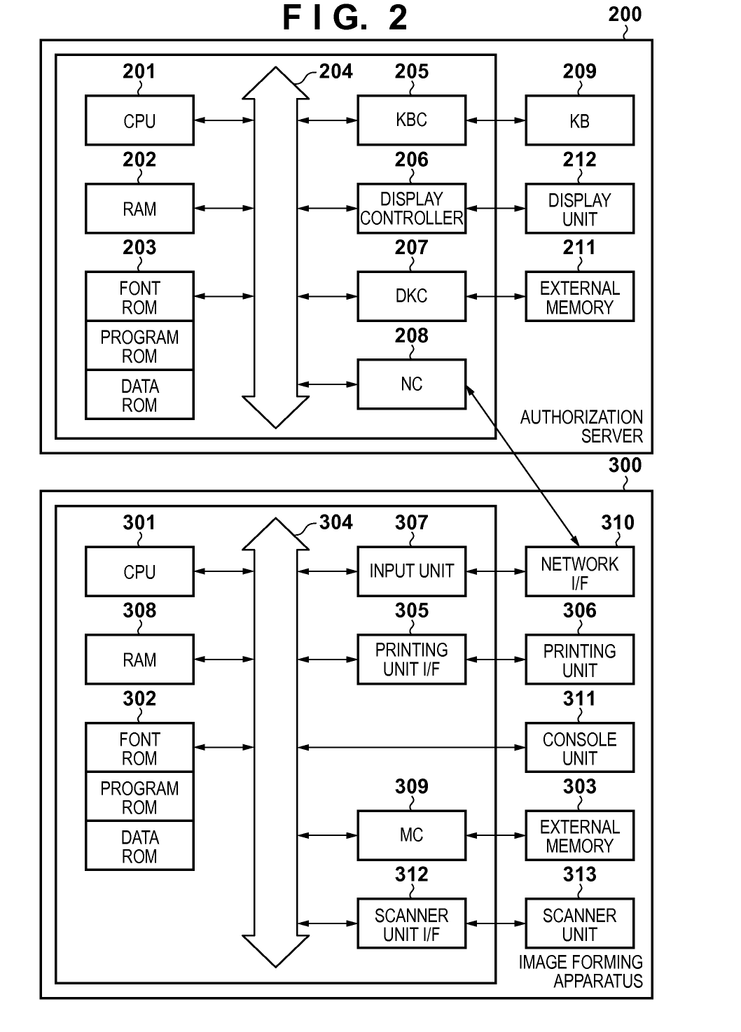

FIG. 2 is a block diagram for showing hardware configurations of the authorization server 200 and the image forming apparatus 300 according to the first embodiment. Here, the authorization server 200 and the image forming apparatus 300 are communicatively connected via the WAN 100 and the LAN 101.

Firstly, explanation will be given for constituent elements of the authorization server 200. Note, the hardware block diagram shown in FIG. 2 is equivalent to a hardware block diagram of general information processing apparatus, and it is possible to adapt the hardware configuration of a general-purpose information processing apparatus to the authorization server 200 of the first embodiment. Also, this is not only the case for the authorization server 200, and the same is true for the resource server 210.

A CPU 201 executes programs, such as an OS or an application, stored in a program ROM of a ROM 203, or loaded from an external memory 211, such as a hard disk drive, into a RAM 202. Then, each block connected to a system bus 204 is controlled by the CPU 201. Here, an OS is an abbreviation for an operating system that operates on a computer, and the operating system will be referred to as the OS hereinafter. Processing of each sequence explained later can be realized by execution of such programs. The RAM 202 serves as a main memory, a work area, or the like, for the CPU 201. A keyboard controller (KBC) 205 controls a key input from a keyboard (KB) 209 or a pointing device (not shown). A display controller 206 controls displaying to a display unit 212. A disk controller (DKC) 207 controls an access to the external memory 211, which may be a hard disk drive for storing various data. A network controller (NC) 208 executes communication control processing between the image forming apparatus 300 and other devices connected via the WAN 100 or the LAN 101.

Note, in all of the later described explanation, the hardware execution agent in the server if not identified specifically is the CPU 201, and the software agent is an application program installed in the external memory 211.

Next, explanation will be given for constituent elements of the image forming apparatus 300.

A CPU 301 controls each block connected to a system bus 304 based on a control program loaded into a RAM 308 from a ROM 302 or an external memory 303. An image signal generated by processing of the CPU 301 is output as print data to a printing unit 306 (printer engine) via a printing unit I/F 305, and printed. Also, the CPU 301 is capable of communication processing for communicating with the authorization server 200 via an input unit 307 and a network interface 310, and is capable of reporting information of the image forming apparatus 300, or the like, to the authorization server 200. A control program of the CPU 301, or the like, is stored on a program ROM in the ROM 302. A font ROM in the ROM 302 stores font data, or the like, for use in generating print data or display data. In a case where the image forming apparatus does not contain the external memory 303, which is a hard disk drive or the like, a data ROM (nonvolatile RAM) in the ROM 302 stores information for performing transmission and reception with the authorization server 200, or the like. The RAM 308 is a RAM that functions as a main memory, a work area, or the like, of the CPU 301, and configuration is taken such that a memory capacity can be extended by an option RAM connected to an expansion port (not shown). Also, the RAM 308 is used as a loading area for output information, an environment data storage area, an NVRAM, or the like. Access to the external memory 303 is controlled by a memory controller (MC) 309. The external memory 303 is connected as an option, and stores font data, an emulation program, form data, or the like. Also, a console unit 311 is provided with a display device, or the like, comprising a touch panel function, and displays switches operated by a user and messages to the user. A scanner unit 313 scans an original document and generates image data corresponding to an image of the original document. A scanner unit interface 312 controls an interface between the CPU 301 and the scanner unit 313. Note, in all of the later described explanation, the hardware execution agent in the image forming apparatus 300 if not identified specifically is the CPU 301, and the software agent is an application program installed in the external memory 303.

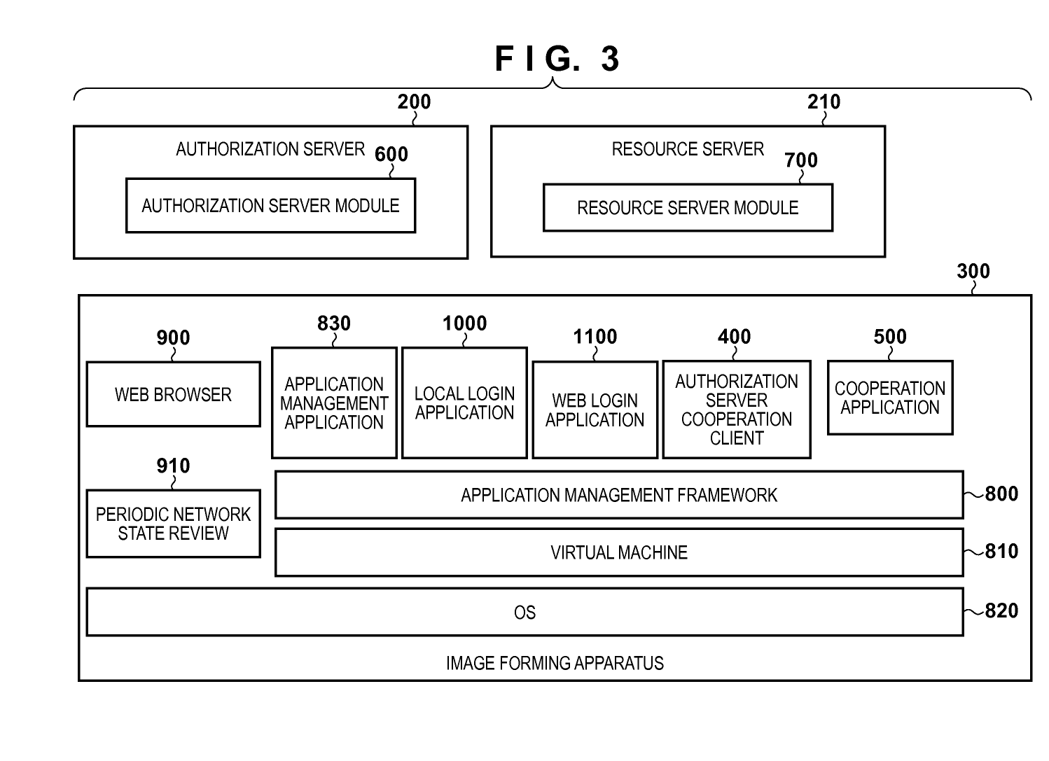

FIG. 3 depicts a view for showing a configuration of each software module of the authorization server 200, the resource server 210 and the image forming apparatus 300 according to the first embodiment.

In the figure, the authorization server 200 comprises an authorization server module 600, and the resource server 210 comprises a resource server module 700.

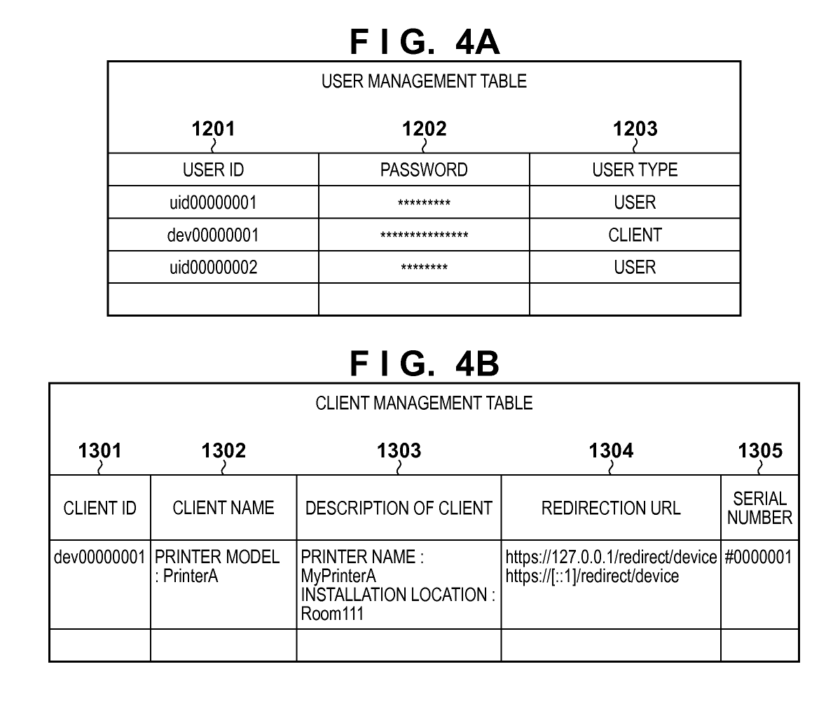

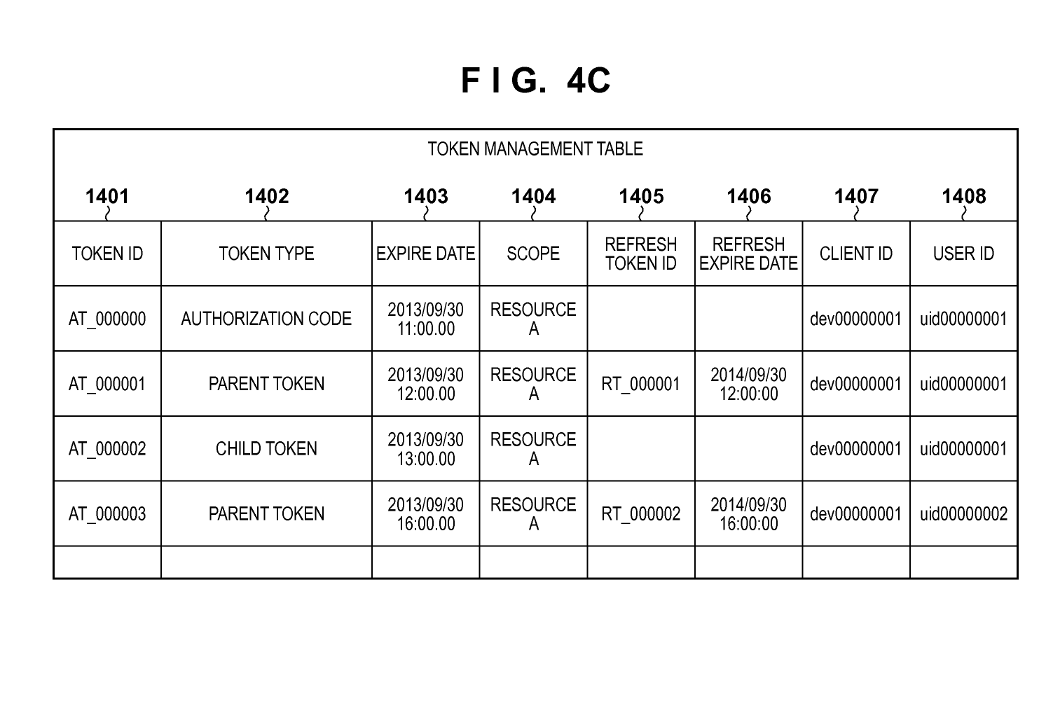

In the image forming apparatus 300, the CPU 301 realizes the functions of a software module in FIG. 4 by controlling each application by executing an OS 820 stored in the ROM 302 or the external memory 303. A real-time OS is generally used for the OS 820, but a general-purpose OS such as Linx (registered trademark) has been used recently. Regarding a virtual machine 810, Java VM (registered trademark), for example, is well known. The virtual machine 810 is a virtual application execution environment operating as an application controlled by the OS 820. An application management framework 800 is provided with a function for managing a life cycle of an application under management, which is operating in the application execution environment provided by the virtual machine 810. An application management framework 800 is also provided with an I/F for controlling the application management framework 800 and a function for publishing an I/F for mediating processing requests between each application. Here, a life cycle indicates a status of the application including application installation, activation, termination and uninstallation.

The application management framework 800 according to the first embodiment will be explained as OSGi (Open Services Gateway initiative) (registered trademark) defined by the OSGi alliance. A cooperation application 500 for cooperating with an authorization server cooperation client 400, a local login application 1000, a Web login application 1100 and a resource service runs in the execution environment on the virtual machine 810. Also, life cycles of these applications are managed by the application management framework 800. An application management application 830 receives and executes installation or an initiation requests for various applications from a user via a control interface for life cycle management published by the application management framework 800.

Here, the image forming apparatus 300 has the application management application 830, the local login application 1000, a Web browser 900 and a periodic network state review 910 by default. The authorization server cooperation client 400 and the cooperation application 500 are installed later via the application management application 830 and the application management framework 800. The Web browser 900 is a user agent for using the WWW.

FIGS. 4A through 4C depict views for explaining data tables stored in the external memory 211 by the authorization server 200 according to the first embodiment. Rather than in the external memory of the authorization server 200, these data tables may be stored in a different server configured to be able to communicate via the LAN 101.

FIG. 4A depicts a view for illustrating an example of a user management table. This user management table stores, in association with a client (a user, including a device), an identifier of the user, and a password.

The user management table comprises a user identifier 1201, a password 1202, and a user type 1203. The authorization server 200 is provided with a function for authenticating each user or client by validating a combination of information of the user identifier 1201 and the password 1202, and if the combination is correct, generating authorization information. Here, for a user type, there are user and client (device).

FIG. 4B depicts a view for illustrating an example of a client management table. This client management table stores information of a client (device).

The client management table comprises a client identifier 1301, a client name 1302, a description of client 1303, a redirection URL 1304, and a serial number 1305. The client identifier 1301 is associated with the user identifier 1201 of the user management table in FIG. 4A, and these are capable of referencing each other. The client name 1302, the description of client 1303, and the redirection URL 1304 are for values used in a sequence of OAuth described later. The serial number 1305 is for a value registered in a case where a client is the image forming apparatus 300, and a value capable of identifying uniquely the image forming apparatus 300. In this client management table, the client information of the user identifier (dev00000001) of the user management table in FIG. 4A is registered.

FIG. 4C depicts a view for illustrating an example of a token management table, and information of a token, which is issued by a client, a user or an authorization server permitted by the authorization server 200, is stored in the table.

The token management table comprises a token identifier 1401, a token type 1402, an expiration date 1403, a scope 1404, a refresh token identifier 1405, a refresh expiration date 1406, a client identifier 1407 and a user identifier 1408. The processing of the access token management table will be explained later in detail.

Here, for example, a parent token having the token identifier “AT_{—}000001” indicates a token in a case where a user (uid00000001) transfers authority to a image forming apparatus (dev00000001) in association with the resource A.

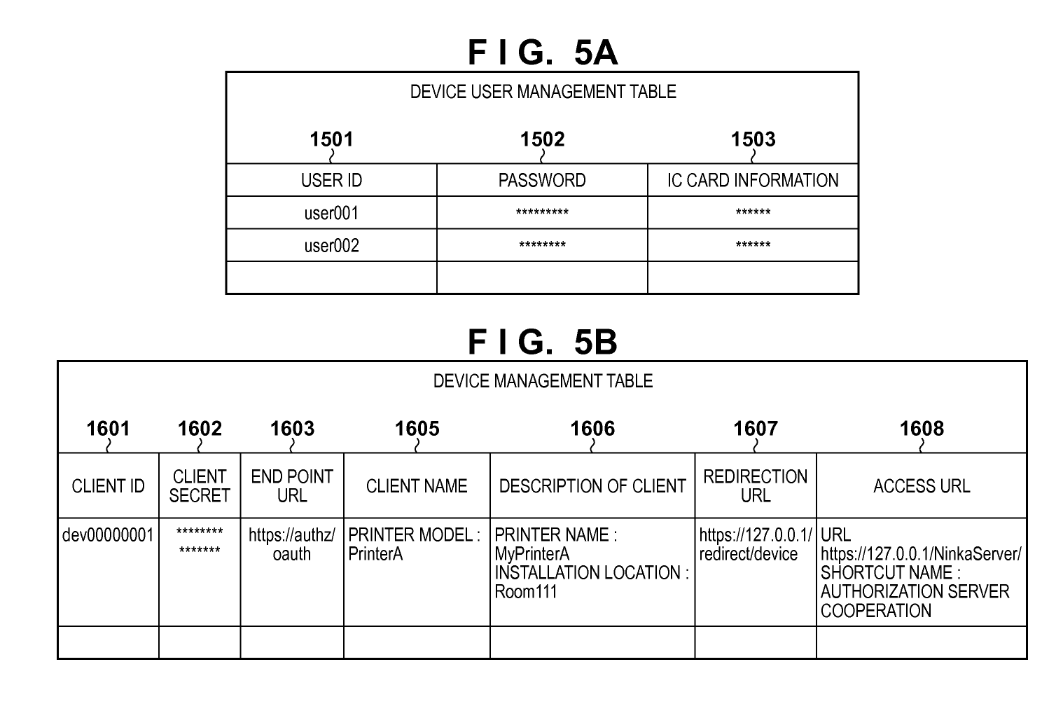

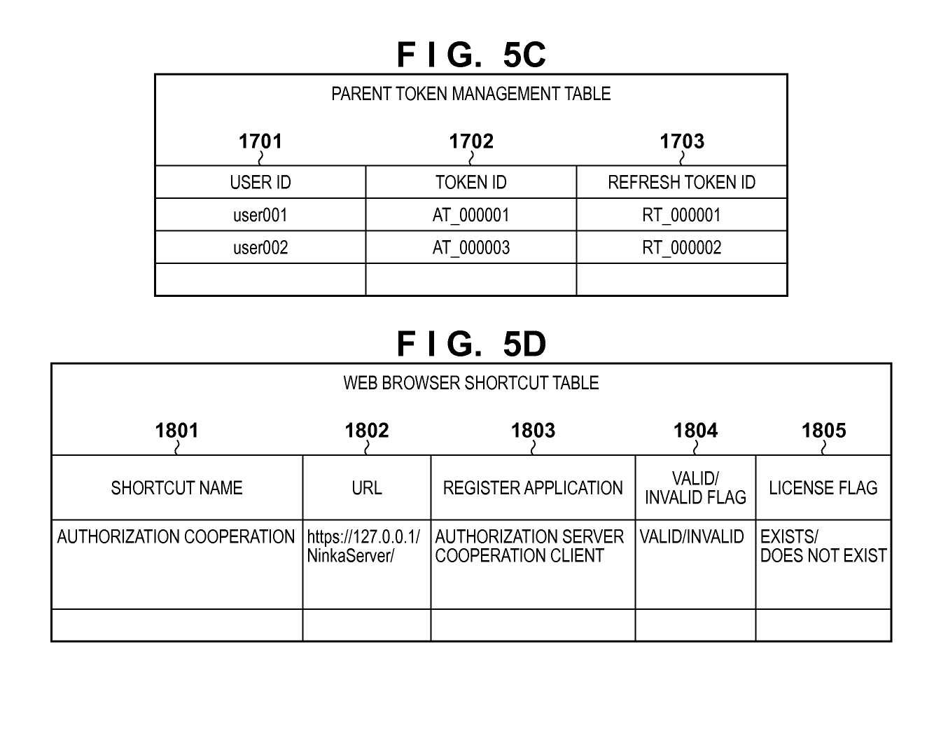

FIGS. 5A through 5D depict views for explaining data tables stored in the external memory 303 by the image forming apparatus 300 according to the first embodiment.

FIG. 5A depicts a view for illustrating an example of a device user management table. This device user management table stores in association with the user identifier of the image forming apparatus 300, the password of the user and IC card information.

The device user management table can be referenced and updated from the local login application 1000 and the Web login application 1100. Also, this table is stored on the external memory 303 of the image forming apparatus 300 in the first embodiment, but configuration may be taken such that this table is stored on a different server that the image forming apparatus 300 is capable of communicating with via the LAN 101. The device user management table comprises a user identifier 1501, a password 1502 and IC card information 1503. The local login application 1000 displays a screen (not shown) of the console unit 311 for receiving an input of a user identifier and a password from a user using an input screen of the image forming apparatus 300. Then, it is verified whether or not the combination of the user identifier and the password inputted via the screen is a match with any of the combinations of the user identifier 1501 and the password 1502 of the device user management table. When the combination is a match, the user is authenticated by generating a login context including the information of the user identifier 1501.

Also, the local login application 1000 obtains the IC card information from an IC card reader (not shown) connected to the image forming apparatus 300. And, it is verified whether or not the IC card information matches the information of the IC card information 1503 of the device user management table, and if the IC card information mathes, the user is authenticated by generating the login context including the information of corresponding user identifier 1501. The Web login application 1100 displays a screen (not shown) for receiving the user identifier and the password of the user with the Web browser 900. Then, it is verified whether or not the combination of the user identifier and the password inputted via the screen is a match with any of the combinations of the user identifier 1501 and the password 1502, and if the combination is a match, the user is authenticated by generating a login context including the information of the user identifier 1501. Here, the login context is an object for which the information of the user identifier 1501 of the user for which the authentication was received is set. Configuration can be alternatively taken such that attribute information of a user, for example, information such as a domain to which the user belongs, an electronic mail address of the user, or the like, may be set.

FIG. 5B depicts a view for illustrating an example of a device management table.

The device management table can be referenced or updated only from the authorization server cooperation client 400. The device management table comprises a client identifier 1601, a client secret 1602, an end point URL 1603, a client name 1605, a description of client 1606, a redirection URL 1607 and an access URL 1608. Here, the client identifier 1601 and the client secret 1602 respectively correspond to the user identifier 1201 and the password 1202 of the user management table (FIG. 4A) issued and stored by the authorization server 200 in advance. Furthermore, the client name 1605, the description of client 1606, the redirection URL 1607 and the access URL 1608 are also stored in the client management table (FIG. 4B) of the authorization server 200. Also, data similar to the information registered with the client identifier 1301 of the client management table and the serial number 1305 of the image forming apparatus 300 in FIG. 4B is stored in the device management table. The client information is registered or updated in the authorization server 200 by the authorization server cooperation client 400 upon activation of the authorization server cooperation client 400 and initiation of the authorization cooperation. The registration and the updating of the client information will be explained later in detail.

The end point URL 1603 is a URL of an end point for OAuth published by the authorization server 200. The access URL 1608 includes a URL and a shortcut name, accessed upon initiation of the authorization and accessed from the Web browser, which are published by the authorization server cooperation client 400.

FIG. 5C depicts a view for illustrating an example of a parent token management table. The parent token management table manages a parent token issued in a case where a user transfers an authority to the image forming apparatus 300.

The parent token management table can be referenced or updated only from the authorization server cooperation client 400. The parent token management table comprises a user identifier 1701, an access token identification 1702 and a refresh token identifier 1703. The access token identification 1702 and the refresh token identifier 1703 respectively correspond to the access token identifier 1401 and the refresh token identifier 1405 in the access token management table in FIG. 4C. The processing of the parent token management table will be explained later in detail.

FIG. 5D depicts a view for illustrating an example of a Web browser shortcut table.

The Web browser shortcut table can be referenced or updated from the Web browser 900, the authorization server cooperation client 400 and the application management application 830. The Web browser shortcut table comprises a shortcut name 1801, a URL 1802 and a register application 1803. Here, the shortcut name 1801, the URL 1802 and the register application 1803 are registered upon activation of the authorization server cooperation client 400. The registration of the Web browser shortcut information will be explained later in detail.

The shortcut name 1801 is a title provided on a GUI as a shortcut button (instruction unit) of the Web browser 900. The URL 1802 is a URL functioning as an end point for activating an initiation screen of the Web browser 900 upon the pressing of the shortcut button. The register application 1803 is a title of an application for which the shortcut button is registered. A valid/invalid flag 1804 is a flag validated by determining that a resource service cooperation succeeds when the activation processing of the authorization server cooperation client 400 has completed normally. Also, if a disconnection state of the network connection is recognized from a monitoring result of a network communication status checked by the periodic network state review 910, the valid/invalid flag 1804 is made to be invalid and temporarily the shortcut is caused to be unusable in a case where the network cannot be used. If the network status returns to normal, the valid/invalid flag 1804 is set to valid. A license flag 1805 is a flag for determining whether or not a license of the Web browser 900 is installed. The license is installed via the application management application 830 and the application management framework 800. The application management application 830 updates the information of the license flag 1805 upon the installation/uninstallation of the license. The authorization server cooperation client 400 obtains the information of the existence or absence of installation of the license from the application management application 830 upon generation of the Web browser shortcut table.

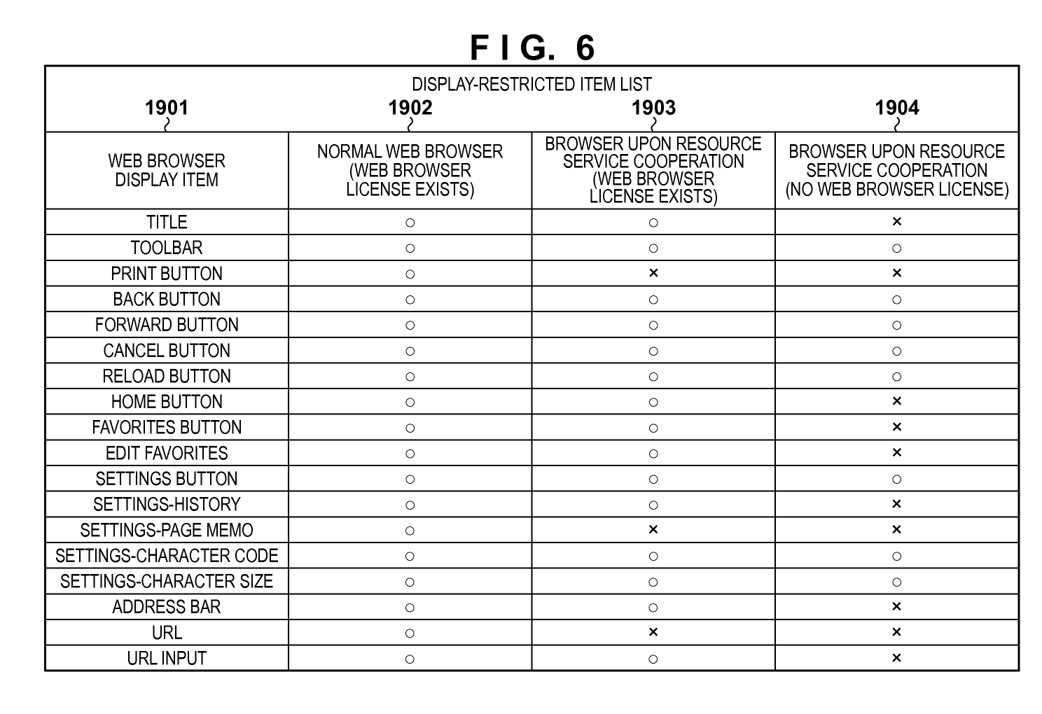

FIG. 6 depicts a view for illustrating an example of a list of display-restricted items according to the first embodiment.

The list of display-restricted items can be referenced or updated from the Web browser 900, the authorization server cooperation client 400 and the application management application 830. The list of display-restricted items manages which items to display out of the display items in the display items of Web browser 1901 upon a normal Web browser execution or a resource service cooperation browser execution. The Web browser 900 refers to the list of display-restricted items and controls the items displayed upon displaying on the console unit 311 of the image forming apparatus 300. The normal Web browser 1902 indicates items that are displayed when the license is installed and the resource service cooperation is not executed, or the resource service cooperation browser display is not performed.

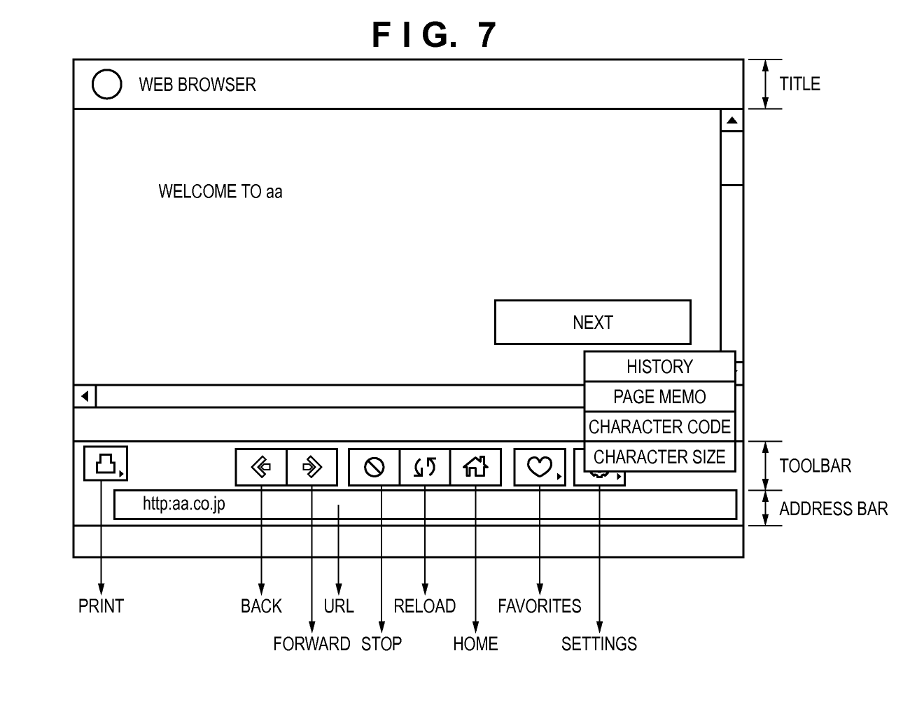

FIG. 7 depicts a view for illustrating an example of a screen of the console unit 311, displayed by a normal Web browser, for which a resource service cooperation is not performed, and which is not a resource service cooperation browser display. This corresponds to a display example based on the normal Web browser 1902. In FIG. 7, because settings buttons are instructed, in addition to the standard display items, settings-history, settings-page memo, settings-character code, and settings-character size are displayed.

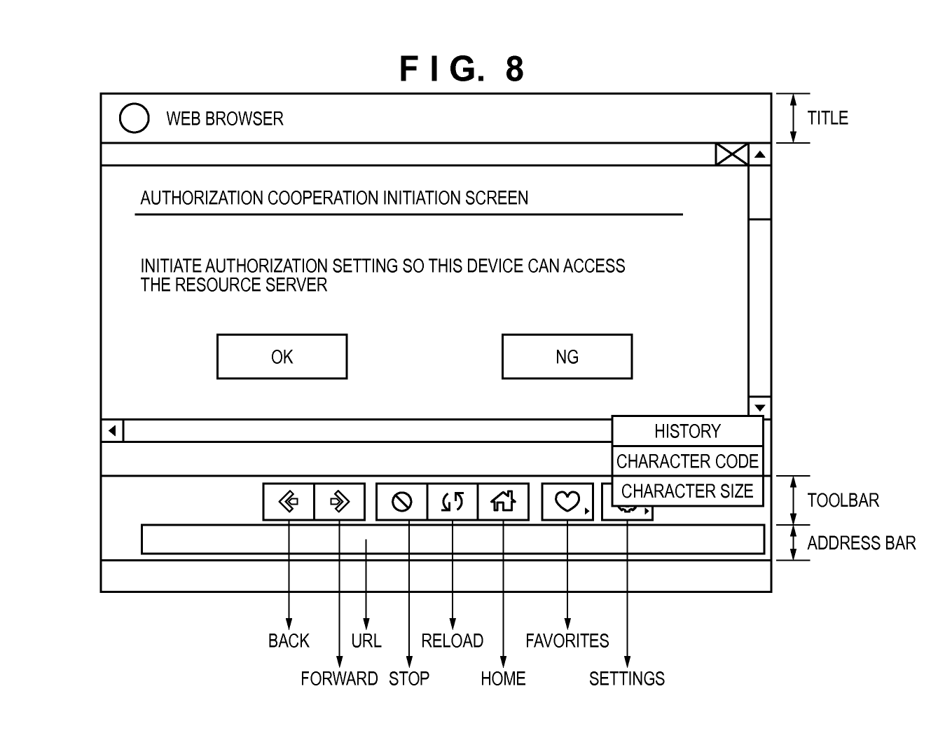

A resource service cooperation browser (Web browser license exists) 1903 of FIG. 6 indicates items that are displayed when the license of the Web browser is installed, and the resource service cooperation browser display is performed. In the first embodiment, for reasons of security, the print button, the settings-page memo, and the URL are not displayed. A display example of such a case is shown in FIG. 8.

FIG. 8 depicts a view for illustrating an example of a screen, displayed by a Web browser where a license is installed, which is a resource service cooperation browser display.

As is clear when comparing to the previously described FIG. 7, because cooperation with the resource service is being performed, a button for instructing an initiation of an authorization setting for accessing the resource service is displayed in FIG. 8. Also, in FIG. 8, in accordance with the items 1903 of the resource service cooperation browser (Web browser license exists) in FIG. 6, the print button, the settings-page memo, and the URL of the address bar of FIG. 7 are not displayed.

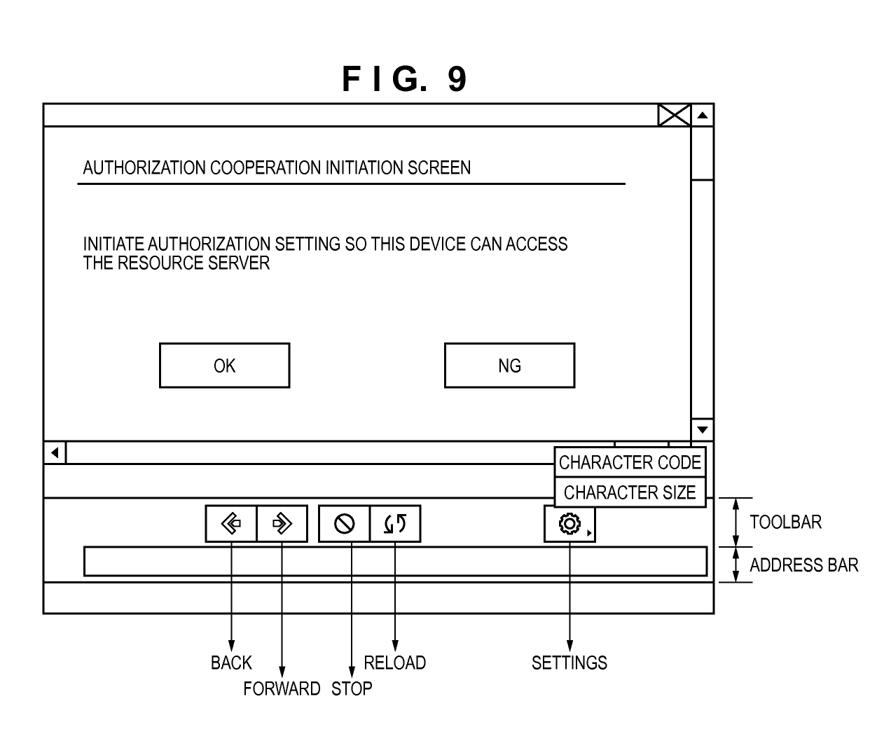

A resource service cooperation browser (Web browser license does not exist) 1904 of FIG. 6 indicates items that are displayed when the license is not yet installed, and the resource service cooperation browser display is performed. Here, so that a situation that is unfair to users that purchased the license of the Web browser does not arise, the display items are limited. A display example of such a case is shown in FIG. 9.

FIG. 9 depicts a view for illustrating an example of a screen, displayed by the Web browser where a license of the Web browser is not yet installed, which is a resource service cooperation browser display.

Here, in accordance with the items 1904 of the resource service cooperation browser (Web browser license does not exist) 1904 in FIG. 6, the title, the print button, the home button, the favorites button, the settings-history, the settings-page memo, the address bar, and the URL shown in FIG. 7 are not displayed.

The authorization server cooperation client 400, upon activation of the application, performs a registration or an update of client information to the authorization server 200, and performs a registration of a Web browser shortcut.

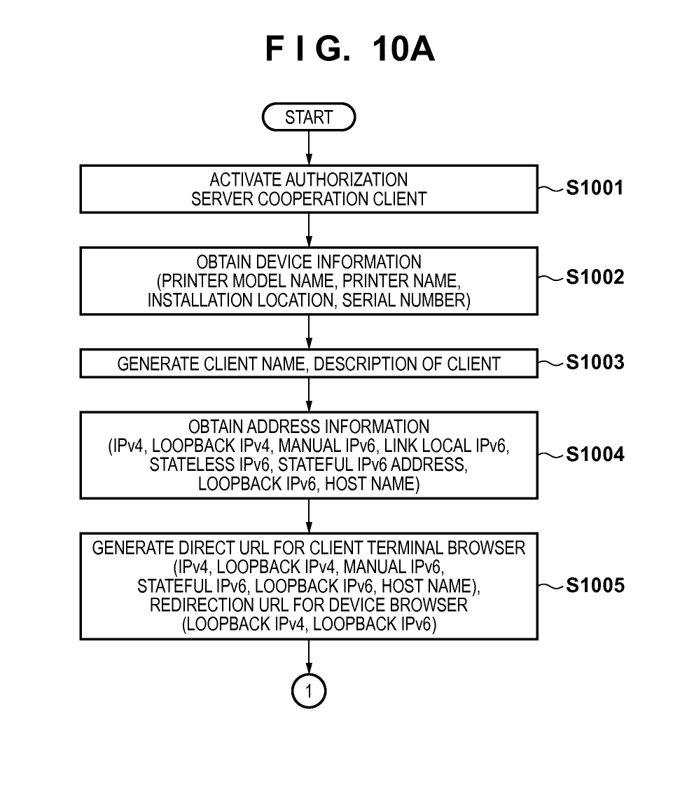

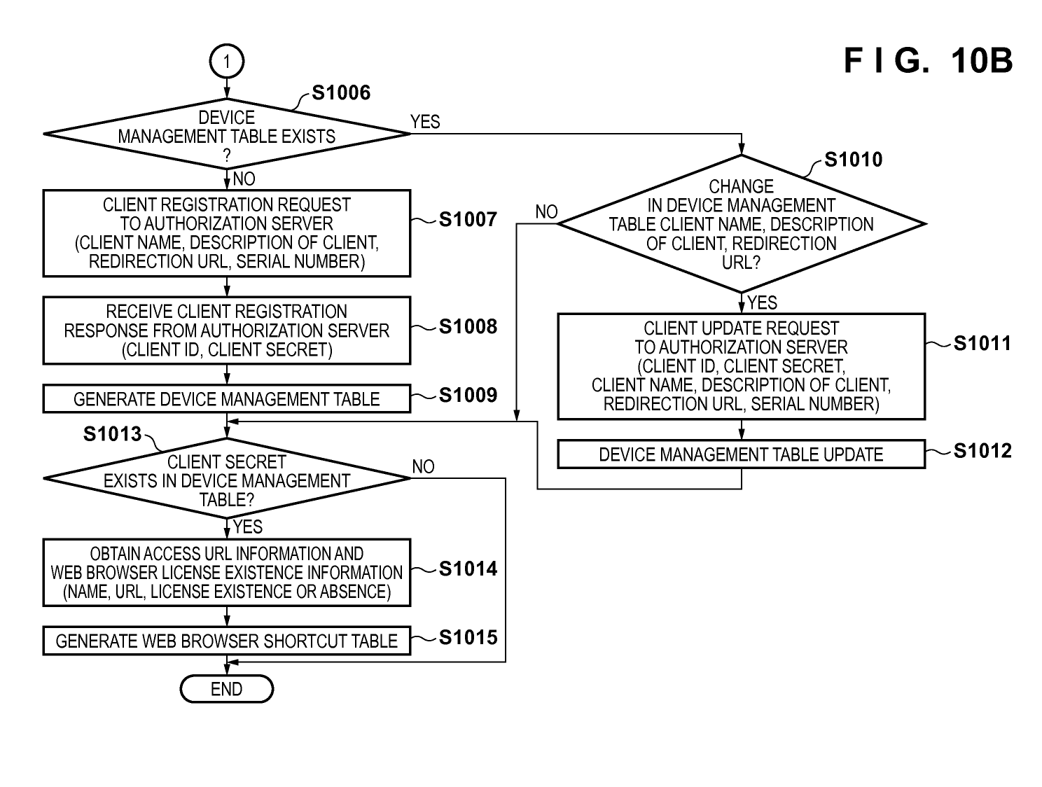

FIGS. 10A and 10B are flowcharts for describing a registration or an update of client information and registration processing of the Web browser shortcut upon activation of the authorization server cooperation client 400 according to the first embodiment. Note that the processing illustrated by the flowchart is realized by the CPU 301 executing a program stored in the program ROM, but here the agents of this processing will be explained as the software modules shown in FIG. 3.

Firstly, in step S1001, the application management framework 800 activates the authorization server cooperation client 400. Next, the processing proceeds to step S1002 and the authorization server cooperation client 400 obtains device information of the image forming apparatus 300. The device information obtained here includes a printer model name, a printer name, an installation location, or a serial number. Next, the processing proceeds to step S1003, and the authorization server cooperation client 400 generates a client name and a description of client using the device information obtained in step S1002. The client name and the description of client generated here are character sequences as shown in the example of FIG. 5B, for example. In the first embodiment, the printer model name is used for the client name and the printer name and the installation location are used for the description of client. However, it is advantageous that the client name and the description of client are character sequences from which the user is able to distinguish the image forming apparatus 300 because the client name and the description of client are displayed on a later described authorization confirmation screen. Here, the printer name and the installation location can be changed to any value by a user, and in a case where a modification is performed, it is necessary to change the client name and the description of client as well.

Next, the processing proceeds to step S1004 and the authorization server cooperation client 400 obtains address information of the image forming apparatus 300. The address information may be an IPv4 address, a loopback IPv4 address, a manual IPv6 address, a link local IPv6 address, a stateless IPv6 address, a stateful IPv6 address, a loopback IPv6 address, or a host name. Here there will be the possibility that the IPv4 address, the manual IPv6 address, the link local IPv6 address, the stateless IPv6 address, the stateful IPv6 address, and the host name will be changed due to the network environment. Next, the processing proceeds to step S1005 and the authorization server cooperation client 400 generates a device browser redirection URL based on the address information obtained in step S1004. The device browser redirection URL is generated as an FQDN of a loopback IPv4 address or a loopback IPv6 address.

The redirection URL 1607 shown in FIG. 5B is an example of the generated device browser redirection URL. In the first embodiment, https is used a transfer protocol, and redirect/device is assumed to be an end point of the device browser redirection URL.

Next, the processing proceeds to step S1006 (FIG. 10B) and the authorization server cooperation client 400 determines whether or not the device management table of FIG. 5B is already held. In a case where it is determined that the device management table is not created, the processing proceeds to step S1007. In step S1007, the authorization server cooperation client 400 performs a request for registration of a client to the authorization server 200 with the client name, the description of client, and the redirection URL generated in step S1003 and step S1005 and the serial number obtained in step S1002. Next, the processing proceeds to step S1008, and the authorization server cooperation client 400 receives a client identifier and a client secret as a registration response to the request for registration of the client from the authorization server 200. Then, the processing proceeds to step S1009, and the authorization server cooperation client 400 generates a device management table (FIG. 5B), stores the device management table in the external memory 303, and the processing proceeds to step S1013. Also, the authorization server cooperation client 400 generates a URL, and a shortcut name, that the authorization server cooperation client 400 publishes to be accessed from the Web browser, and stores the URL and the shortcut name in the device management table as the access URL 1608. Here, the device management table stores the client name, the description of client, and the redirection URL generated in step S1003 and in step S1005 respectively, and stores the end point of the authorization server 200 in the end point URL 1603.

Meanwhile, if it is determined, in step S1006, that the authorization server cooperation client 400 stores the device management table, the processing proceeds to step S1010. In step S1010, the authorization server cooperation client 400 determines whether there is a change in the client name 1605, the description of client 1606, or the redirection URL 1607 by comparing with the generation results of step S1003 and step S1005. It is possible that the printer name and the installation location used for the client name and the description of client, or the IPv4 address, the manual IPv6 address, the link local IPv6 address, the stateless IPv6 address, the stateful IPv6 address, or the host name have changed. When it is determined in step S1010 that there is no change, the processing proceeds to step S1013, and when it is determined that there is a change, the processing proceeds to step S1011, and the authorization server cooperation client 400 issues a client update request to the authorization server 200. In the client update request, the client identifier 1601 and the client secret 1602 of the device management table, and the client name, the description of client, and the redirection URL generated in step S1003 and in step S1005 are informed. Furthermore, the serial number obtained in step S1002 is communicated. Then, if the client update request succeeds, the processing proceeds to step S1012, and the authorization server cooperation client 400 updates the device management table with the information communicated in the client update request, and the processing proceeds to step S1013.

In step S1013, the authorization server cooperation client 400 determines whether the client secret 1602 exists in the device management table. Here, if it is determined that the client secret 1602 exists, the processing proceeds to step S1014, and in a case where it is determined that the client secret 1602 does not exist, the processing completes. In step S1014, the authorization server cooperation client 400 obtains the access URL 1608 in the device management table, and obtains the Web browser license existence/absence information from the application management application 830. Then the processing proceeds to step S1015, and based on the obtained information, a Web browser shortcut table as shown in FIG. 5D is generated and stored in the external memory 303, and the processing completes.

With the above explained processing, generation or update of the device management table as shown in FIG. 5B is possible, and when the client secret exists in the device management table, the Web browser shortcut table as shown in FIG. 5D is generated.

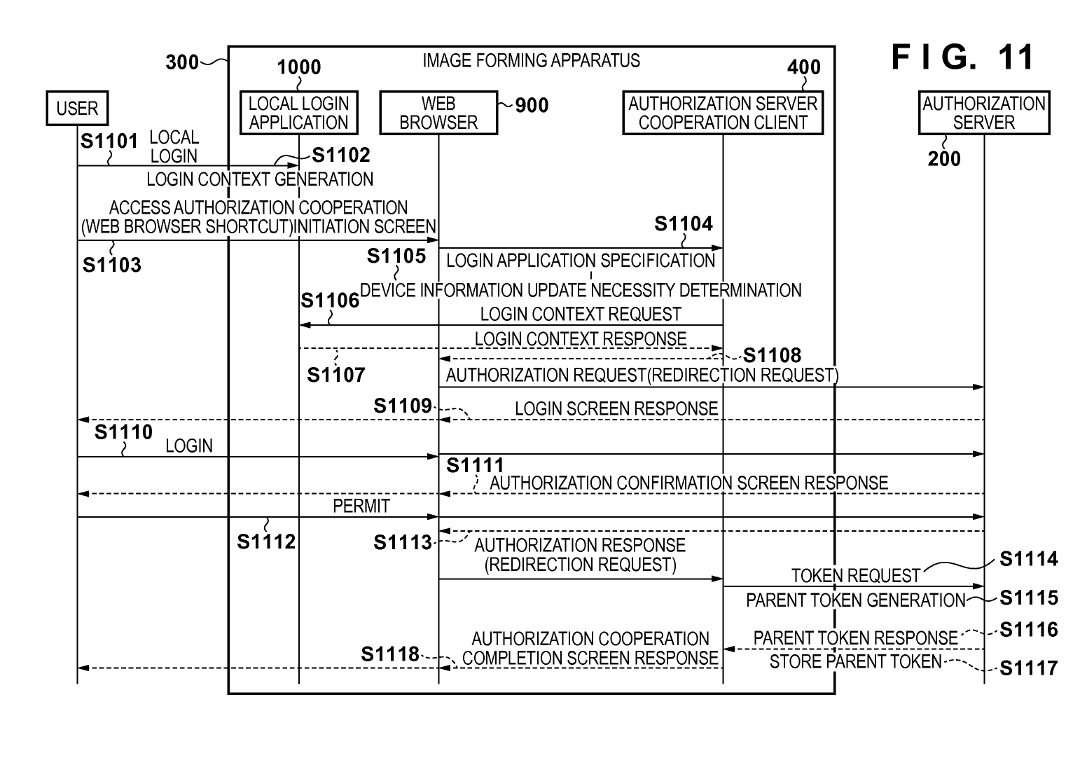

FIG. 11 depicts a view for explaining an obtainment sequence of a parent token of the image forming apparatus according to the first embodiment. FIG. 11 shows an obtainment sequence of a parent token using the Web browser 900 of the image forming apparatus 300, and this sequence is an operation performed only once using the Web browser 900 of the image forming apparatus 300 when a user first uses the image forming apparatus 300.

Firstly, in S1101, a user logs in to the image forming apparatus 300 using a login scheme that uses an input screen of the image forming apparatus 300 that the local login application 1000 provides. Here, the user having the user identifier of “user001” logs in. With this, in S1102, the local login application 1000 generates a login context that includes this “user001”. Next, in S1103, the Web browser 900, referencing the Web browser shortcut table (FIG. 5D), displays a shortcut on the console unit 311 of the image forming apparatus 300. Then, the user executes the Web browser 900 by selecting the shortcut. Using the Web browser 900, the user accesses the URL 1802 in order to initiate the authorization cooperation of the authorization server cooperation client 400. Here, the Web browser 900 displays the screen for confirming the authorization cooperation initiation as shown in previously described FIG. 9, for example. The display items in such a case are restricted by the display conditions. Details of the restricted item determination scheme will be explained later. FIG. 9 shows a case in which the display condition is for a resource service cooperation browser (Web browser license does not exist).

The authorization server cooperation client 400 specifies a local login with the login application specification of S1104 when the authorization cooperation initiation is received. Next, in S1105, whether an update of the device information is necessary or not is determined, and in a case where the update of the device information is necessary, a device information update request is made to the authorization server 200. In S1106, the authorization server cooperation client 400 makes a request to the local login application 1000 for a login context. In response to this request, in S1107, the local login application 1000 sends the login context to the authorization server cooperation client 400.

Then, in S1108, the Web browser 900 transmits a redirection request, for requesting an OAuth authorization request, for the URL recited in the end point URL 1603 of the device management table. In this OAuth authorization request, information of the client identifier 1601 and the redirection URL 1607 of the device management table (FIG. 5B) is included. The redirection URL included in this authorization request is a device browser redirection URL, and a URL that matches the request FQDN received in S1103 is used. Also, in OAuth, it is possible to include a scope that shows an authority range for which authorization is desired in the authorization request. In the first embodiment, explanation is given having a scope A be requested as the scope.

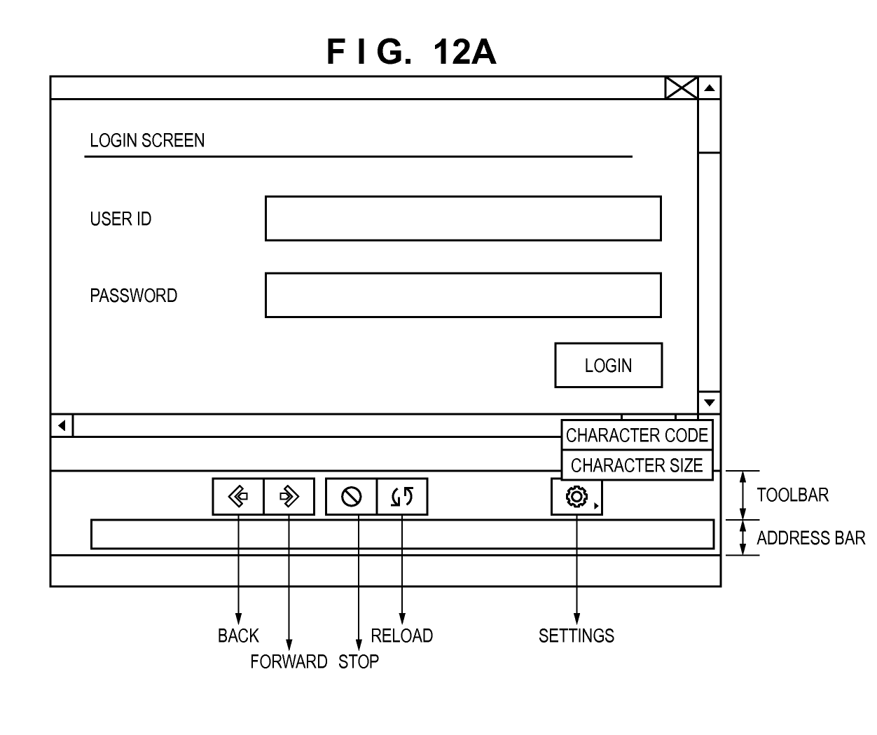

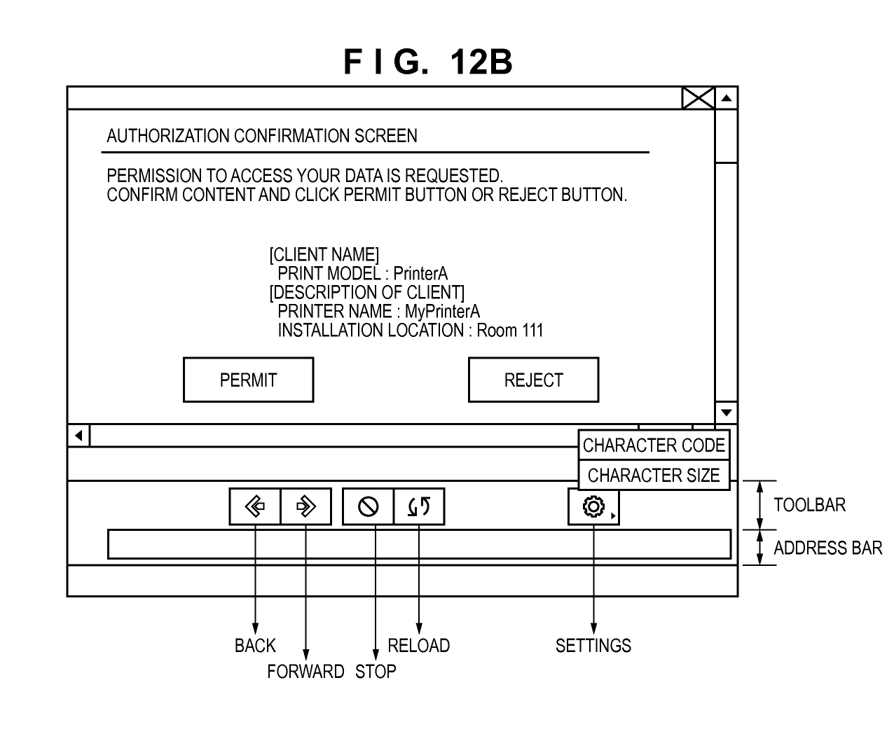

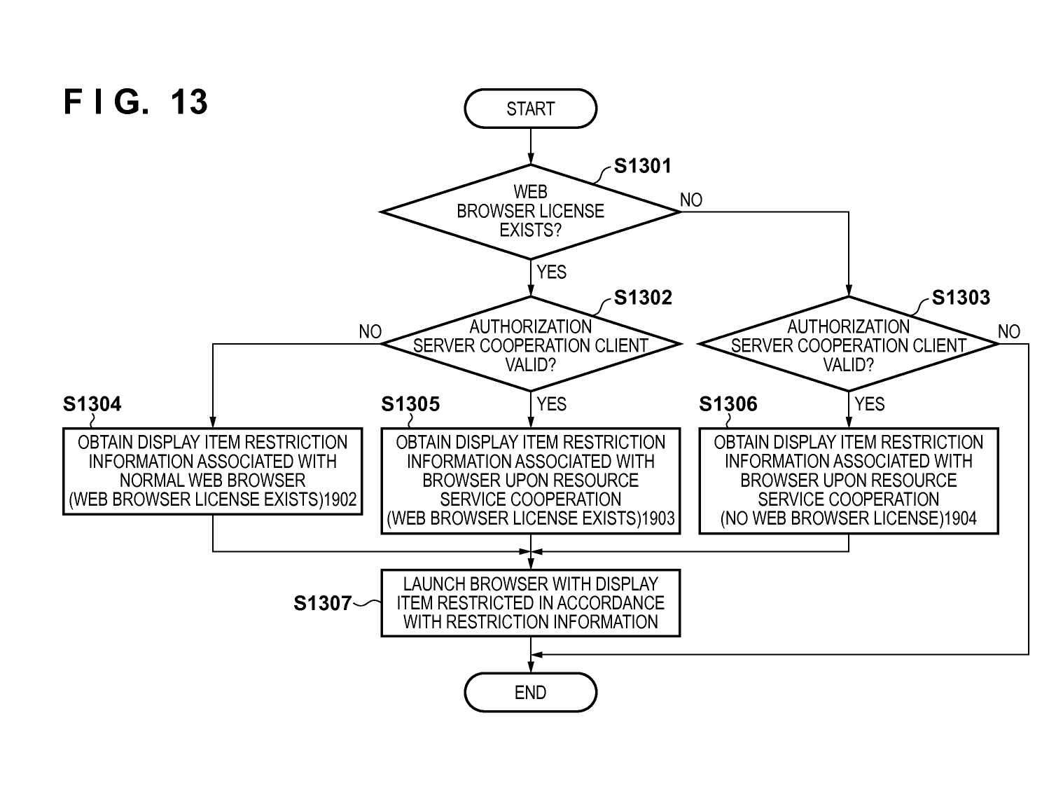

The authorization server 200, having received the authorization request, responds, in S1109, to the Web browser 900 with a login screen for authenticating the user. An example of the login screen here is shown in FIG. 12A.

FIG. 12A depicts a view for illustrating an example of the login screen, for authenticating the user, which is displayed by the Web browser 900 of the image forming apparatus according to the first embodiment.

Next, in S1110, the user executes a login by inputting a user identifier and a password into the login screen which is shown on the Web browser 900 (FIG. 12A). With this, the authorization server 200 executes the following processing for generating authorization information linked to the user identifier in a case where it is verified whether or not the received user identifier and password combination match information registered in the user management table (FIG. 4A) and the combination is a match. The authorization server 200 verifies whether the combination of the client identifier and the redirection URL included in the authorization request matches information registered in the client management table of FIG. 4B. If the result of the verification is that the combination is a match, in S1111, the client name 1302 and the description of client 1303 of the client management table (FIG. 4B) are obtained, an authorization confirmation screen is generated, and a response is made to the Web browser 900. Here, response is made storing authorization information as cookie information in the Web browser 900.

FIG. 12B depicts a view for illustrating an example of authorization confirmation screen displayed by the Web browser 900 of the image forming apparatus 300 according to the first embodiment.

Here, user data access permission is requested of the user, and it is requested that in response to this a “permit” button or a “reject” button be clicked.

Note that, while in the first embodiment, the client name 1302 and the description of client 1303 are displayed on the authorization confirmation screen, configuration may be taken such that information of the user logging in is displayed on the screen.

Next, in S1112, when the user clicks the “permit” button on the authorization confirmation screen displayed on the Web browser 900, the authorization server 200 that receives the permission issues an authorization code and registers the authorization code in the access token management table (FIG. 4C). Here, an identifier of the issued token is registered for the access token identifier 1401, “authorization code” is registered for the token type 1402, and the expiration date 1403 and the scope 1404 are registered. Also, the client identifier received upon the authorization request is registered for the client identifier 1407, and the user identifier linked to the authorization information transmitted as a cookie from the Web browser 900 is registered for the user identifier 1408. Then, in S1113, as an authorization response, the authorization server 200 makes a redirection request of the Web browser 900 to redirect to the redirection URL attaching the access token identification of the authorization code.

The authorization server cooperation client 400, having received the authorization response, makes, in S1114, a token request to the authorization server 200. The token request includes the access token identification of the authorization code obtained in the authorization response, and the client identifier 1601, the client secret 1602, and the redirection URL 1607 of the device management table (FIG. 5B).

The authorization server 200, having received the token request, performs the following verification, and in a case where the verified information is correct, a parent token is generated in S1115. The authorization server 200 verifies whether the combination of the client identifier and the client secret received in the token request matches a combination of the user identifier 1201 and the password 1202 registered in the user management table (FIG. 4A).

Next, it is verified whether the access token identification of the authorization code received in the token request is registered in the access token management table (FIG. 4C) and whether the expiration date has not passed. Then, it is verified whether or not the client identifier and the redirection URL received in the token request match the client identifier 1407 and the redirection URL 1304 specified by the access token identification in the access token management table respectively. Here, configuration may be taken such that a column is added to the access token management table rather than the client management table, that the redirection URL 1304 is registered in the column of the access token management table when the authorization code is issued, and that the added redirection URL is verified.

Here, in a case where all of items of the information verified are found to be correct, the authorization server 200 generates a parent token, and sends the access token identification of the parent token to the authorization server cooperation client 400 in response (S1116). Here a refresh token identifier simultaneously issued is included in the content of the response. For the parent token, the issued token identifier is registered for the access token identifier 1401, “parent token” is registered for the token type 1402, the expiration date 1403 is registered, and the client identifier 1407 and the user identifier 1408 are registered as information inherited from the authorization code. Here, a refresh token for refreshing the parent token is issued, and the refresh token identifier 1405 and the refresh expiration date 1406 are registered.

The authorization server cooperation client 400, having obtained the parent token access token identification and refresh token identifier, obtains the device user identifier from the login context obtained from the local login application 1000 in S1106 and S1107. Then, in the parent token management table of FIG. 5C, the device user identifier, the access token identification, and the refresh token identifier are stored (S1117). Next, in S1118, the authorization server cooperation client 400 responds to the Web browser 900 with a screen that indicates an authorization cooperation completion, and the process is terminated.

FIG. 13 is a flowchart for describing processing for determining display items in accordance with the display item restrictions in FIG. 6 when a screen is displayed by the Web browser 900 of the image forming apparatus 300 according to the first embodiment. Note that the processing illustrated by the flowchart is realized by the CPU 301 executing a program stored in the program ROM.

When the Web browser 900 is executed, firstly, in step S1301, the authorization server cooperation client 400, referencing the Web browser shortcut table of FIG. 5D, confirms the license flag 1805 of the Web browser. Here, when it is determined that the license exists, the processing proceeds to step S1302, and when it is determined that the license does not exist, the processing proceeds to step S1303. In step S1302 or in step S1303, it is determined whether or not the authorization server cooperation client 400 is valid by confirming the valid/invalid flag 1804. When, in step S1302, the authorization server cooperation client 400 determines that the authorization server cooperation client 400 is valid, the processing proceeds to step S1305, and the display items 1903 of the resource service cooperation browser for the case where the license of the Web browser of FIG. 6 exists are obtained, and the processing proceeds to step S1307. Meanwhile, when, in step S1302, the authorization server cooperation client 400 is not valid, the processing proceeds to step S1304, the display items of the normal Web browser 1902 of FIG. 6 are obtained, and the processing proceeds to step S1307.

Also, in step S1303, when the authorization server cooperation client 400 determines that the authorization server cooperation client 400 is valid, the processing proceeds to step S1306, and the display items 1904 of the resource service cooperation browser for the case where the Web browser license does not exist of FIG. 6 are obtained, and the processing proceeds to step S1307. Meanwhile, when, in step S1303, the authorization server cooperation client 400 is not valid, the process is terminated. In step S1307, the Web browser 900 is activated with display items restricted in accordance with the obtained display restriction information.

(Authorization Server Cooperation Client Uninstallation)

In a case where the authorization server cooperation client 400 is no longer used, the authorization server cooperation client 400 is uninstalled via the application management application 830 and the application management framework 800. Here, the application management application 830 deletes information that the register application 1803 matches with the authorization server cooperation client 400 from the Web browser shortcut table of FIG. 5D.

According to the first embodiment, as explained above, even in a case where the license of the Web browser does not exist, usage of the Web browser is possible as long as the resource service cooperation is valid. Also, by displaying the Web browser with display items restricted, it is possible to use the Web browser without a situation that is unfair to users that purchased the license arising.

### Second Embodiment

In the previously described first embodiment, explanation was given for an example in which a display item restriction storage unit for storing the list of the display item restrictions (FIG. 6) is the external memory 303 of the image forming apparatus 300. However, in such a case, when updating the list of display-restricted items, each and every image forming apparatus needs to be updated, and so effort is required in environments managing a plurality of image forming apparatuses. Also, there are cases where the display items restricted differ based on the cooperating resource services. In the second embodiment, explanation will be given for an example in which the display item restriction storage unit is arranged on the resource server 210, and the image forming apparatus 300 obtains the list of display-restricted items from the resource server 210.

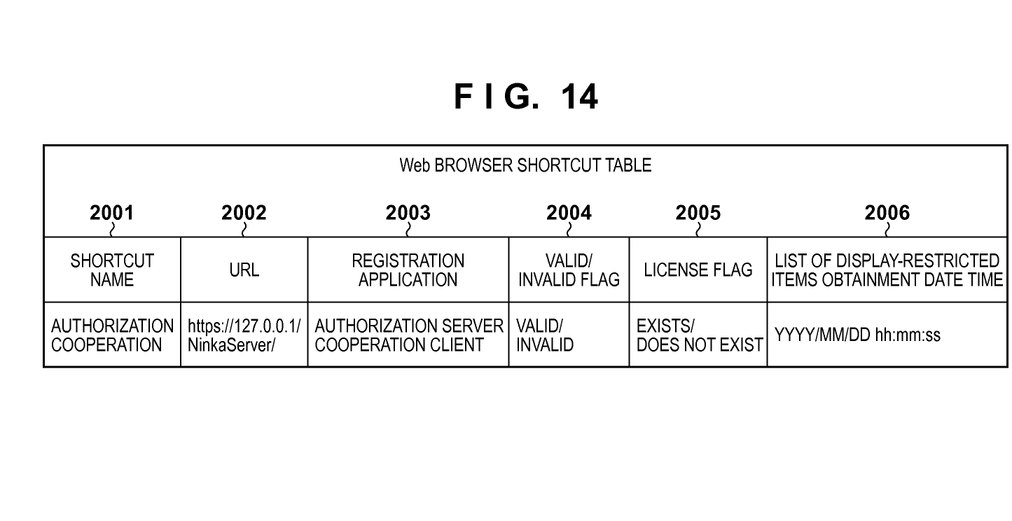

Because the system configuration, the configuration of each type of server, the configuration of the image forming apparatus 300, and the respective configurations of the modules of the authorization server 200, the resource server 210, and the image forming apparatus 300 in the second embodiment are the same as in FIGS. 1 through 3 of the first embodiment, their explanation will be omitted. Also, because the data tables that the authorization server 200 stores in the external memory 211 are the same as in FIGS. 4A through 4C, their explanation will be omitted. Furthermore, because the data tables that the image forming apparatus 300 stores in the external memory 303 are the same as in FIGS. 5A through 5D, their explanation will be omitted. Note that the Web browser shortcut table of FIG. 5D is changed to the Web browser shortcut table shown in FIG. 14.

FIG. 14 depicts a view for illustrating an example of the Web browser shortcut table according to the second embodiment of the present invention. Because reference numerals 2001-2005 in FIG. 14 correspond to reference numerals 1801-1805 in FIG. 5D, corresponding explanation is omitted.

A difference between FIG. 14 and FIG. 5D is that a list of display-restricted items obtainment date and time 2006 is added in FIG. 14. The list of display-restricted items obtainment date and time 2006 records a date and time at which the list of display-restricted items 1900 is obtained from the resource server 210.

The list of display-restricted items of the previously described FIG. 6 is stored as a table in the external memory 211 by the resource server 210. Regarding the information of this table, the information is the same as that of FIG. 6 of the previously described first embodiment, and so explanation is omitted.

Also, because the processing of the client information registration/updating and the Web browser shortcut registration upon the authorization server cooperation client 400 activation is the same as that of the previously described first embodiment, explanation is omitted.

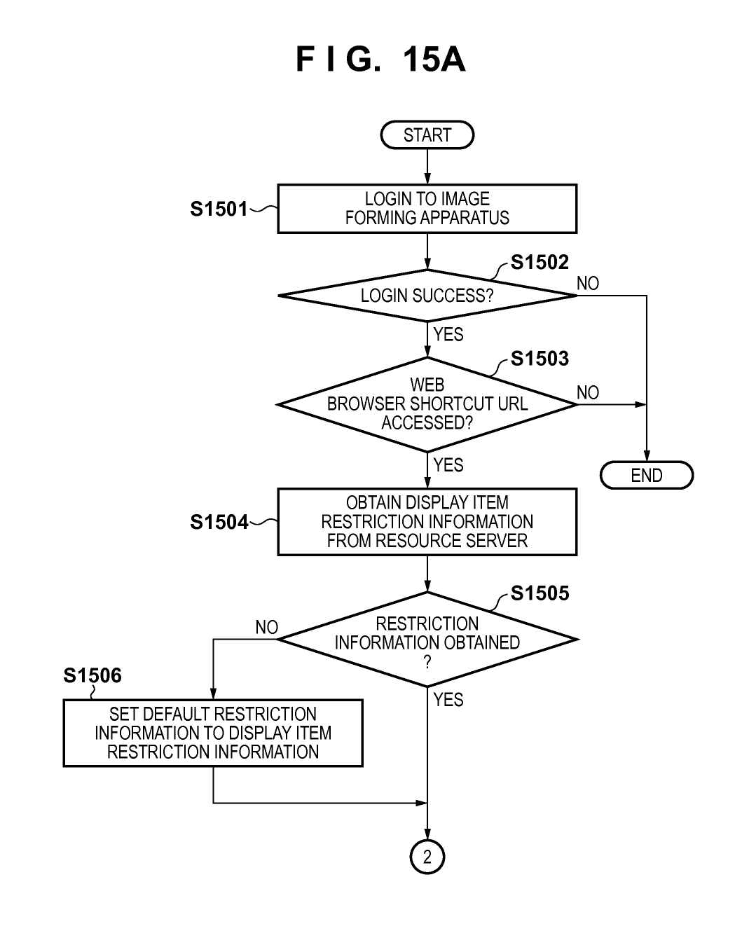

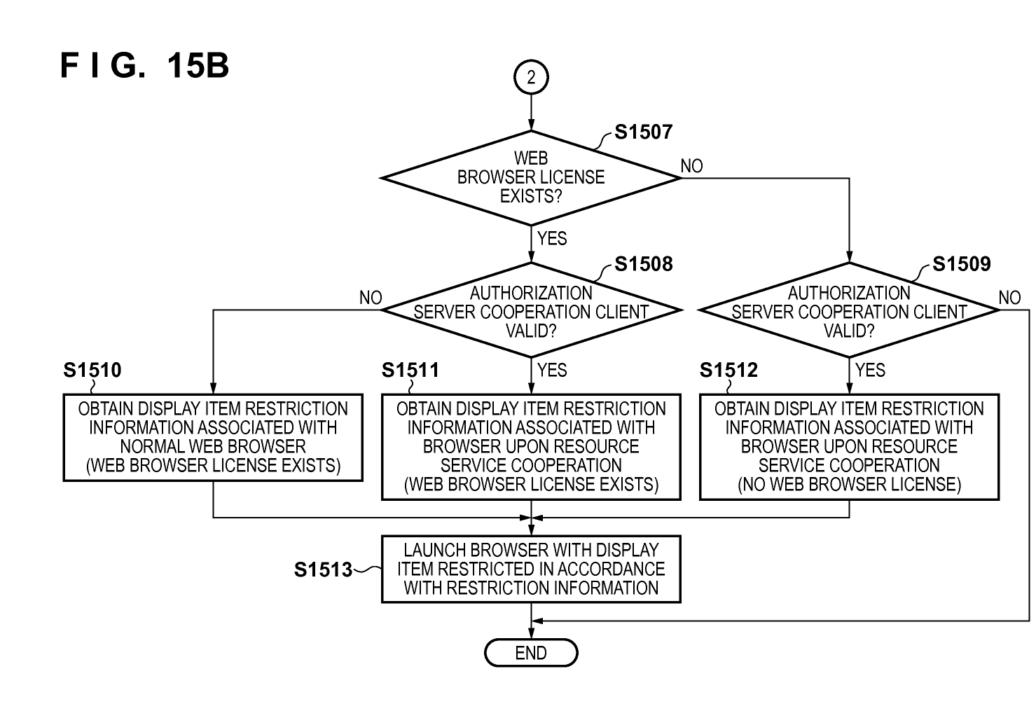

FIGS. 15A and 15B are flowcharts for describing processing for obtaining the list of display-restricted items performed by the image forming apparatus 300 according to the second embodiment. Note that the processing illustrated by the flowchart is realized by the CPU 301 executing a program stored in the program ROM, but here the agents of this processing will be explained as the software modules shown in FIG. 3.

When, in step S1501, the cooperation application 500 accepts a user login into the image forming apparatus 300, the processing proceeds to step S1502, and the cooperation application 500 determines whether or not the login succeeds. When the login succeeds, the processing proceeds to step S1503, and the cooperation application 500 determines whether or not the Web browser shortcut URL 2002 is accessed. When, in step S1503, it is determined that the Web browser shortcut URL 2002 is accessed, the processing proceeds to step S1504, and the cooperation application 500 tries to obtain the list of display-restricted items of FIG. 6 from the resource server 210. Note that in a case where the login fails in step S1502, or when, in step S1503, the Web browser shortcut URL 2002 is not accessed, the process is terminated.

In step S1505, the cooperation application 500 determines whether or not the list of display-restricted items is able to be obtained, and if the list of display-restricted items cannot be obtained, the processing proceeds to step S1506, default restriction information is set, and the processing proceeds to step S1507. The default restriction information may be something that the image forming apparatus 300 comprises to begin with, or may be information obtained from the authorization server 200 upon the parent token obtainment.

Meanwhile, in a case where it is determined in step S1505 that the list of display-restricted items is able to be obtained, the processing proceeds to step S1507 (FIG. 15B), and the cooperation application 500, referencing the Web browser shortcut table of FIG. 14, confirms the license flag 2005 of the Web browser. When it is determined that there exists a Web browser license in step S1507, the processing proceeds to step S1508, and it is determined whether or not the authorization server cooperation client 400 is valid. If the authorization server cooperation client 400 is valid, the processing proceeds to step S1511, display item restriction information for the resource service cooperation browser (Web browser license exists) of FIG. 6 is obtained, and the processing proceeds to step S1513. If, in step S1508, the authorization server cooperation client 400 is invalid, the processing proceeds to step S1510, the display item restriction information of the normal Web browser (Web browser license exists) 1902 of FIG. 6 is obtained, and the processing proceeds to step S1513.

When it is not determined that there exists a Web browser license in step S1507, the processing proceeds to step S1509, and it is determined whether or not the authorization server cooperation client 400 is valid. If the authorization server cooperation client 400 is valid, the processing proceeds to step S1512, display item restriction information for the resource service cooperation browser (Web browser license does not exist) of FIG. 6 is obtained, and the processing proceeds to step S1513. Also, when, in step S1509, the authorization server cooperation client 400 is not valid, the process is terminated. In step S1513, the Web browser 900 is activated with display items restricted in accordance with the obtained display restriction information.

According to the second embodiment, as explained above, there is the effect that a restriction of display items can be performed for each resource service.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)BD) the present invention can also be realized by a computer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-211431, filed Oct. 8, 2013, which is hereby incorporated by reference herein in its entirety.

What is claimed is:

1. An image forming apparatus capable of executing a Web browser application and a cooperation application for cooperating with a server, the apparatus comprising:
a first determination unit configured to determine whether or not a license of the Web browser application is valid;
a second determination unit configured to determine whether or not the cooperation application for cooperating with the server is valid; and
a display control unit configured to display a screen of the Web browser application in which a display item is restricted in accordance with the determinations by the first determination unit and the second determination unit.

2. The image forming apparatus according to claim 1, wherein the screen is a screen for instructing an initiation of an authorization setting for the image forming apparatus to access the server.

3. The image forming apparatus according to claim 1, further comprising a storage unit configured to store a validity/invalidity of the license of the Web browser application, a validity/invalidity of the cooperation with the server, and a URL of an authorization server.

4. The image forming apparatus according to claim 1, further comprising a restricted item storage unit configured to store a validity/invalidity of the license of the Web browser application, and a list of display items for which a display item in the screen is restricted which corresponds to a validity/invalidity of the cooperation application.

5. The image forming apparatus according to claim 1, wherein the display control unit restricts, in a case where the first determination unit determines that the license of the Web browser application is invalid, and the second determination unit determines that the cooperation application is valid, a display item related to a function that is not able to be executed in a case where the license of the Web browser is invalid, and
restricts, in a case where the first determination unit determines that the license of the Web browser is valid, and the second determination unit determines that the cooperation application is valid, a display of a URL.

6. The image forming apparatus according to claim 4, further comprising a registration unit configured to, when the cooperation application is added, perform a registration of information including a shortcut of the Web browser application upon activation of the added application.

7. The image forming apparatus according to claim 4, wherein the restricted item storage unit is arranged in the server.

8. The image forming apparatus according to claim 1, wherein the first determination unit determines in accordance with an instruction of a user input via the screen.

9. A method of controlling an image forming apparatus capable of executing a Web browser application and a cooperation application for cooperating with a server, the method comprising:
determining whether or not a license of the Web browser application is valid;
determining whether or not the cooperation application for cooperating with the server is valid; and
displaying a screen of the Web browser application in which a display item is restricted in accordance with the determinations in the determining steps.

10. A non-transitory computer-readable storage medium storing a program for causing a computer to function as an image forming apparatus capable of executing a Web browser application and a cooperation application for cooperating with a server, the apparatus comprising:
a first determination unit configured to determine whether or not a license of the Web browser application is valid;
a second determination unit configured to determine whether or not the cooperation application for cooperating with the server is valid; and
a display control unit configured to display a screen of the Web browser application in which a display item is restricted in accordance with the determinations by the first determination unit and the second determination unit.
